(19) United States
(12) Patent Application Publication
(10) Pub. No.: US 2021/0230059 A1
(43) Pub. Date: Jul. 29, 2021

(54) MAGNETIC GLASS FIBRE COMPONENT

(71) Applicant: Jason Paul Pomeroy, Highbridge, Somerset (GB)

(72) Inventor: Jason Paul Pomeroy, Highbridge, Somerset (GB)

(21) Appl. No.: 17/052,755

(22) PCT Filed: Apr. 16, 2019
(86) PCT No.: PCT/GB2019/051085

§ 371 Date: Nov. 3, 2020

(30) Foreign Application Priority Data
May 23, 2018 (GB) 1808502.7

(51) Int. Cl. C03C 25/38; C08K 3/22; C08L 67/02; C03C 25/1095; B29C 70/88

(52) U.S. Cl. CPC C03C 25/38; C08K 3/22; C08L 67/02; B29K 2105/0854; B29C 70/88; C08K 2201/01; C08K 2003/2275; C03C 25/1095

(57) ABSTRACT

The present invention provides a magnetic glass fibre component comprising at least one glass fibre component coated and/or impregnated with an iron ore containing resin.

### BACKGROUND OF INVENTION

Magnetic materials are used in a diverse range of applications in a variety of different industries. For example, magnetic materials can be found in body scanners within the healthcare industry, in computers, TVs and loud speakers within the entertainment industry, TVs and loud speakers, and in electric motors and generators within the automobile industry. Magnetic materials are also used in ornamental articles such as for example paintings, photographs and sculptures.

Conventional magnetic materials are typically composed of steel or ferrous metal. Steel and ferrous metal have however been found to have limited corrosion resistance and are therefore susceptible to rusting when exposed to the environment. Corrosion of steel or ferrous metal based product can significantly reduce the life span of the product. Furthermore, steel and ferrous metal are also relatively heavy and cumbersome to work with.

There is therefore a need for a magnetic product which is cost effective, lightweight, versatile and corrosion resistant.

### SUMMARY OF INVENTION

According to a first aspect, the present invention provides a magnetic glass fibre component comprising at least one glass fibre component coated and/or impregnated with an iron ore containing resin.

The resin may be any suitable resin which can be effectively mixed with the at least one iron ore and deposited on the glass fibre component(s). Suitable resins include, but are not limited to, one or more of: orthophthalic, polyester, isophthalic, epoxy, vinyl ester, or any combination thereof. Preferably, the resin comprises one or more of: orthophthalic or isophthalic resin. Preferably, the resin comprises orthophthalic resin. Preferably, the resin comprises isophthalic resin.

The magnetic glass fibre component is preferably black in colour.

The resin may comprise any suitable iron ore(s) such as for example one or more of: magnetite, hematite, maghemite, and pyrrhotite, or any combination thereof. Preferably the iron ore is magnetite. Preferably, the iron ore is hematite. Preferably, the iron ore is maghemite. Preferably, the iron ore is pyrrhotite.

The iron-ore containing resin may comprise any suitable amount of one or more iron ore(s) within the resin(s). The resin may comprise at least 10% w/w iron ore(s), preferably at least 20% w/w iron ore(s), for example about 30% w/w iron ore(s). The resin may comprise no more than 50% w/w iron ore(s), preferably no more than 45% w/w iron ore(s), preferably no more than 40% w/w iron ore(s). The resin may comprise between 10% and 50% w/w iron ore(s), preferably between 20% and 50% w/w iron ore(s), preferably between 20% w/w and 45% w/w iron ore(s), more preferably between 20% w/w and 40% w/w iron ore(s), for example between 30% ad 40% w/w iron ore(s).

In one embodiment, the magnetic fibre component comprises one or more of: orthophthalic or isophthalic resin, in which the resin comprises at least 10% w/w iron ore(s), preferably between 10% and 50% w/w iron ore.

In one embodiment, the magnetic fibre component comprises magnetite in orthophthalic resin.

The glass fibre component may be any suitable component such as for example a continuous glass multifilament strand or glass fibre matting. Glass fibre matting includes any suitable matting such as for example E-glass, C-glass, woven glass, or any combination thereof. The glass fibre component may provide fibres extending within a 2D array or within a 3D array.

The magnetic glass fibre component is preferably corrosion resistant.

According to a second aspect, the present invention provides a method for the production of a magnetic glass fibre component, comprising:
mixing at least one iron ore with at least one resin to provide an iron ore containing resin; and
depositing iron ore containing resin onto at least one glass fibre component.

In one embodiment, the method may further comprise:
obtaining a mould;

coating the mould with a plastic coating prior; and
inserting the at least one glass fibre component into the mould prior to and/or during deposition of the iron ore containing resin onto the glass fibre component(s).

The plastic coating is preferably any coating which enables the resultant magnetic glass fibre component to be easily removed from the mould. Preferably, the plastic coating comprises Gelcoat. In one embodiment, Gelcoat is applied in a liquid state and once cured forms a plastic coating.

The method may further comprise mixing the iron ore containing resin with one or more of a catalyst and/or a hardener.

Suitable catalysts include, but are not limited to, methyl ethyl keton peroxide (MEKP). The percentage of catalyst used is dependent on the temperature at which the method is carried out. The method is preferably carried out at ambient temperature. For example, approximately 3% w/w of catalyst, preferably MEKP, is present if the method is carried out at ambient temperature between 13° C. and 16° C. For example, approximately 2% w/w of catalyst, preferably MEKP, is present if the method is carried out at ambient temperature between 16° C. and 20° C. For example, approximately 1% w/w of catalyst, preferably MEKP, is present if the method is carried out at ambient temperature between 20° C. and 35° C.

The iron ore containing resin is preferably mixed with the one or more catalyst and/or hardener prior to depositing the iron ore containing resin on the glass fibre component.

The method may further comprise introducing additional glass fibre components into the mould after coating at least one glass fibre component with the iron ore containing resin. The additional glass fibre components may be introduced into the mould prior to and/or during deposition of the iron ore containing resin onto the additional glass fibre component(s) to product a composite magnetic glass fibre component having a predetermined thickness.

The method may further comprise layering a plurality of glass fibre components either prior to, during, or after depositing the iron ore containing resin onto each component to produce a composite magnetic glass fibre component having a predetermined thickness.

The magnetic glass fibre component preferably remains within the mould to cure and/or solidify prior to removal from the mould. The duration of time that the component takes to cure and/or solidify is known as the curing time. It is to be understood that the time required for the glass fibre component to cure is dependent on a number of factors, such as for example the amount of catalyst added to the iron-ore containing resin and/or the termperature of the mould and external environment. For example, a higher w/w percentage of catalyst present within the mixture will speed up the curing time but will affect, for example reduce, the working time of the component. For example, the higher the temperature of the mould the quicker the curing time of the component. It is also to be understood that the curing time may be reduced by exposing the iron-ore containing resin to heat and/or UV light, such as provided by heat and/or UV lamps.

In one embodiment, the curing time of the component is preferably at least 30 minutes, preferably at least 1 hour, preferably at least 2 hours, for example about 3 hours. Preferably, the curing time is no more than 10 hours, preferably no more than 7 hours, for example no more than 5 hours. The curing time is preferably in the range of between 30 minutes and 10 hours, preferably between 1 hour and 7 hours, preferably between 3 hours and 5 hours.

In one embodiment, the magnetic glass fibre formed from iron ore containing resin together with 2% w/w catalyst at an ambient temperature of between 16° C. and 20° C. has a curing time of approximately 3 hours.

The resultant magnetic glass fibre component may be shaped into the desired shape within the mould by processes such as for example hand laying, RTM, silicone bagging, vacuum bagging, and/or injection moulding.

According to a further aspect, the present invention provides a method for production of a composite magnetic glass fibre material comprising:

contacting a magnetic glass fibre component as herein described with an additional substrate or core material.

The additional substrate or core material may for example be applied to a free surface of the magnetic glass fibre component. Alternatively, the magnetic glass fibre component may be deposited on a free surface of the additional substrate or core material.

The method may further comprise locating a core material, for example a layer of core material, adjacent to one layer, and preferably between an adjacent pair of layers, of magnetic glass fibre components to form a magnetic composite material. The additional substrate or core material may provide the composite material with predetermined properties.

The additional substrate or core material may for example be a gel coat, a plastic surface, a further glass fibre component.

According to a further aspect, the present invention provides a magnetic material comprising a magnetic glass fibre component as described herein. According to one embodiment, the magnetic material may be a composite material.

The present invention provides magnetic glass fibre components which are durable, versatile, lightweight, corrosion resistant and waterproof.

The present invention may be used to produce magnetic glass fibre components in any desired shape having any suitable dimensions, such as for example tiles, propellers, boat hulls, statues, water slides, stairs, feature walls, rooms etc.

Embodiments of the present invention will now be described in further detail with reference to the accompanying Figures

### BRIEF DESCRIPTION OF FIGURES

FIG. 1 is a Flow diagram of the method for the production of a magnetic glass fibre component according to one

### DETAILED DESCRIPTION

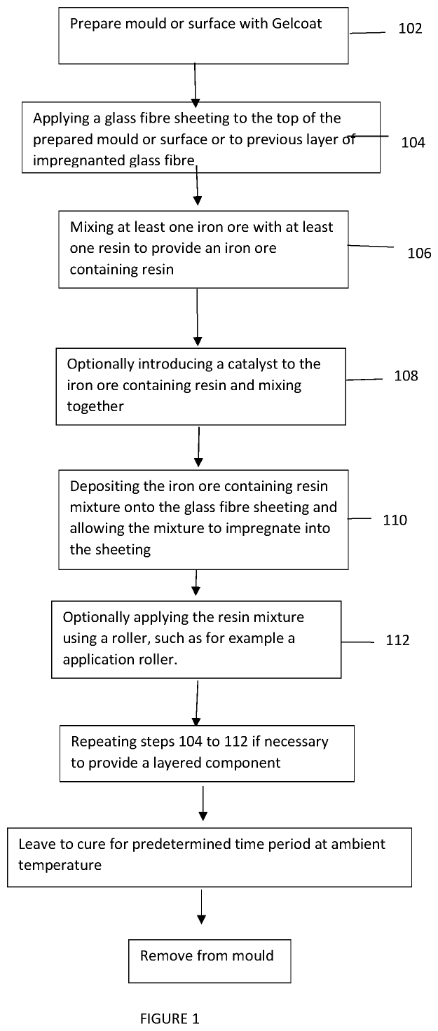

With reference to the FIG. 1, a production mould is prepared having predetermined shape and dimensions for the resultant magnetic glass fibre component. The production mould is lined with a plastic coating, such as for example Gel coat.

A section of fibre glass matting is introduced into the mould such that at least one surface is in contact with the plastic coating.

Magnetite in an amount of at least 10% w/w, preferably in the range of between 10% and 50% w/w, is mixed with orthophthalic resin. It is however to be understood that any suitable iron ore, such as for example hematite, maghemite or pyrrhotite, and any suitable resin such as for example polyester, isophthalic, epoxy, vinyl ester, may be used.

Once fully mixed, the magnetite containing orthophthalic resin turns black in colour. A catalyst or hardener, for example 2% w/w Methyl ethyl ketone peroxide (MEKP) is added to the magnetite containing orthophthalic resin and mixed together at the room temperature of between 16° C. and 20° C.

Once mixed, the magnetite containing orthophthalic resin will slowly start to cure providing a certain amount of ‘working time’ allowing the process to be finished. The magnetite containing orthophthalic resin is applied to the free surface(s) of the fibre glass matting using an application roller during the period of working time to remove air bubbles. It is to be understood that the magnetite containing orthophthalic resin may be applied using any suitable techniques and is not to be limited to roller application.

The magnetite containing orthophthalic resin soaks into the weave of the fibre glass matting to provide magnetic fibre glass. The magnetite containing orthophthalic resin is left to cure or solidify prior to removal of the coated fibre glass component from the mould.

The process can be repeated for multiple layers of fibre glass matting to provide a composite material comprising the desired number of coated layers and having predetermined thickness. The thickness is preferably measured in a direction extending substantially perpendicular to the plane defined by the fibre glass matting. Preferably, the magnetic fibre glass material has a thickness of at least 1 mm, preferably at least 2 mm, for example at least 3 mm. The magnetic fibre glass material may have a thickness of no more than 20 mm, preferably no more than 10 mm, for example no more than 5 mm. The magnetic fibre glass material may have a thickness in the range of between 1 mm and 50 mm, preferably in the range of between 2 mm and 10 mm, more preferably in the range of between 3 mm and 5 mm.

In one embodiment, a core material may be located next to a layer of, and preferably between adjacent layers of, magnetic fibre glass component to provide a composite magnetic fibre glass component. The core material may be composed of any suitable material to provide the resultant composite component with the desired properties.

The coated fibre glass component may be formed using any suitable process such as hand laying, RTM, silicone bagging, vacuum bagging, or injection moulding.

The process provides magnetic fibre glass material which can be formed in the shape of products such as for example tiles, propellers, boat hulls, statues, water slides, stairs, walls, decorative ornaments, and living spaces.

1. A magnetic glass fibre component comprising at least one glass fibre component coated and/or impregnated with an iron ore containing resin, in which the resin comprises one or more resin selected from: orthophthalic and/or isophthalic resin, and in which the resin comprises at least 10% w/w iron ore(s).

2. A magnetic glass fibre component as claimed in claim 1, in which the resin comprises one or more iron ores selected from: magnetite, hematite, maghemite, and pyrrhotite, or any combination thereof.

3. A magnetic fibre component as claimed in claim 2, in which the iron ore is magnetite.

4. A magnetic glass fibre component as claimed in claim 1, in which the iron ore containing resin comprises magnetite in orthophthalic resin.

5. A magnetic glass fibre component as claimed in claim 1, in which the glass fibre component comprises glass fibre matting.

6. A magnetic glass fibre component as claimed in claim 5, in which the glass fibre matting is selected from woven glass, E-glass, C-glass, or any combination thereof.

7. A method for the production of a magnetic glass fibre component, comprising:
mixing at least one iron ore with at least one resin to provide an iron ore containing resin; and
depositing iron ore containing resin onto at least one glass fibre component.

8. A method as claimed in claim 7, in which the at least one glass fibre component is glass fibre matting.

9. A method as claimed in claim 7, further comprising:
obtaining a mould;
coating the mould with a plastic coating prior; and
inserting the at least one glass fibre component into the mould prior to depositing the iron ore containing resin.

10. A method as claimed in claim 7, further comprising mixing the iron ore containing resin with one or more of a catalyst and/or a hardener.

11. A method as claimed in claim 7, further comprising layering the glass fibre components either prior to, during, or after depositing the iron ore containing resin to produce a component having predetermined thickness.

12. A magnetic material comprising a magnetic glass fibre component as claimed in claim 1.

13. A material as claimed in claim 12, in which the material is a composite material.
